(19) United States
(12) Patent Application Publication
(10) Pub. No.: US 2005/0227649 A1
(43) Pub. Date: Oct. 13, 2005

(54) Radio system that simultaneously displays preset channels from multiple bands

(76) Inventors: Jacqueline A. Chestnut, Sterling Heights, MI (US); Charles A. Massol, Milford, MI (US)

Correspondence Address: General Motors Corporation;Legal Staff, Mail Code 482-C23-B21, 300 Renaissance Center, P.O. Box 300, Detroit, MI, 48265-3000, US

(21) Appl. No.: 10/818,467

(22) Filed: Apr. 5, 2004

(51) Int. Cl. G06K 1/00; B41B 1/00; B41J 1/00; B41F 1/00

(52) U.S. Cl. 455/154.1; 455/140

(57) ABSTRACT

A radio system operable to receive signals in a plurality of frequency bands includes a control module and an interface module whereby a user may store a plurality of presets from the bands. The interface module displays to the user a page of the presets for selection of a play frequency therefrom. The page includes frequencies from more than one band.

### FIELD OF THE INVENTION

The present invention relates generally to radio systems, and more particularly to radio systems that simultaneously display preset channels from multiple bands.

### BACKGROUND OF THE INVENTION

Commercially available radio systems allow a user to tune and/or preset channels in a plurality of frequency bands such as AM, FM, weather band (WB), and satellite. As the tuning/preset options increase, it becomes difficult for a radio listener to quickly and easily select channels in different bands. When the user wants to preset channels in multiple frequency bands, the user selects the band and then presets the channel within the band. Likewise, to select a preset channel in a band, the user selects the band and then selects the preset channel.

### SUMMARY OF THE INVENTION

The present invention, in one embodiment, is directed to a radio system that receives signals in multiple frequency bands. The system includes a control module and an interface module that communicates with the control module. The interface module provides at least one of a user interface and a display. The interface module and the control module allow a user to store frequencies as preset frequencies from more than one frequency band. The control module and the interface module present the preset frequencies for selection. At least two of the preset frequencies that are simultaneously presented are from different frequency bands.

In another configuration, a radio system is operable to receive signals at a plurality of frequencies selected by a user. The system includes a control module and an interface module that communicates with the control module to present a subset of the selected frequencies, to allow the user to choose a frequency from the subset for reception by the radio system. The presented subset includes frequencies in a plurality of frequency bands that are presented simultaneously.

In another implementation, the invention is directed to a method of providing signal selection to a user of a radio system that receives signals from a plurality of frequency bands. The method includes presenting to the user a page having a plurality of presets. The user is allowed to set the presets to a plurality of frequencies from more than one of the bands.

Further areas of applicability of the present invention will become apparent from the detailed description provided hereinafter. It should be understood that the detailed description and specific examples, while indicating exemplary embodiments of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a block diagram of a radio system according to one configuration of the present invention;

FIG. 2 is an illustration of a radio system manual interface according to one configuration of the present invention;

FIG. 3 is an illustration of a page for display on a panel interface according to one configuration of the present invention;

FIG. 4 is a flow diagram of a method of configuring a page with presets according to one configuration of the present invention;

FIG. 5 is a flow diagram of a method of changing a page according to one configuration of the present invention;

FIG. 6 is an illustration of an option display according to one configuration of the present invention; and

FIG. 7 is an illustration of a radio system interface according to one configuration of the present invention.

### DETAILED DESCRIPTION OF EXEMPLARY EMBODIMENTS

The following description of various embodiments of the present invention is merely exemplary in nature and is in no way intended to limit the invention, its application, or uses. For purposes of clarity, the same reference numbers will be used in the drawings to identify similar elements. As used herein, the term module and/or device refers to an application specific integrated circuit (ASIC), an electronic circuit, a processor (shared, dedicated, or group) and memory that execute one or more software or firmware programs, a combinational logic circuit, or other suitable components that provide the described functionality. Unless stated otherwise, the terms “frequency” and “channel’ may be used interchangeably herein.

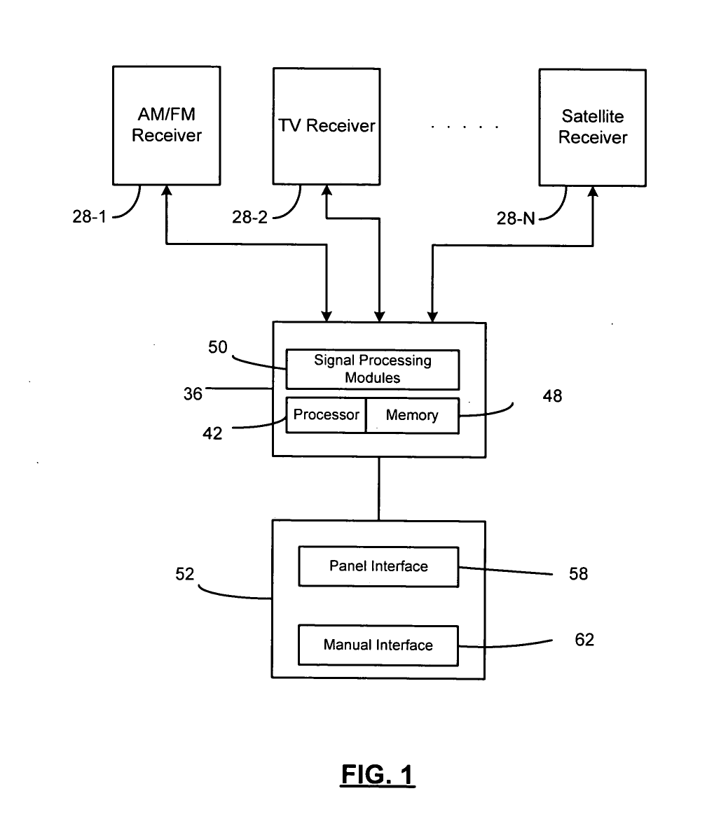

A radio system in accordance with one configuration of the present invention is indicated generally in FIG. 1 by reference number 20. The system 20 is configured for installation in a vehicle, although other configurations for use in other environments also are contemplated. The system 20 includes a plurality of receivers 28-1, 28-2, . . . , and 28-N (collectively receivers 28) that can receive signals at a plurality of frequencies in a plurality of frequency bands. Such frequencies may include but are not limited to frequencies in AM, FM, television, satellite, and/or weather bands. Signals received by the receivers 28 are output to a control module 36. In this exemplary embodiment, the control module 36 is shown to include a processor 42 and memory 48, although there are other suitable ways to implement the control module. The control module 36 may include signal processing modules 50, e.g., one or more A/D converters, D/A converters and/or mixers for processing digital and/or analog signals received by the receivers 28.

The control module 36 is connected with an interface module 52, which is accessible by a driver or passenger of the vehicle. The interface module 52 includes a panel interface 58 and/or a manual interface 62. The panel interface 58 may be a touch screen and is described as such herein, although configurations also are contemplated in which the panel interface 58 includes a radio face plate having “hard” keys, e.g., buttons. In yet another configuration, the panel and manual interfaces 58 and 62 are combined as a single interface.

As further described below, a user may use the interface module 52 to choose (also referred to herein as “preset”) a plurality of frequencies for reception by the radio system 20. The preset frequencies may be stored in the memory 48 and/or in the receiver(s) 28. At least a subset of the preset frequencies can be presented on the interface module 52 to allow the user to select a frequency from the subset for reception by the radio system 20. The displayed subset includes frequencies from a plurality of frequency bands that are displayed simultaneously. As discussed below, the interface module 52 can present subsets of the chosen frequencies using pages, each page including a subset.

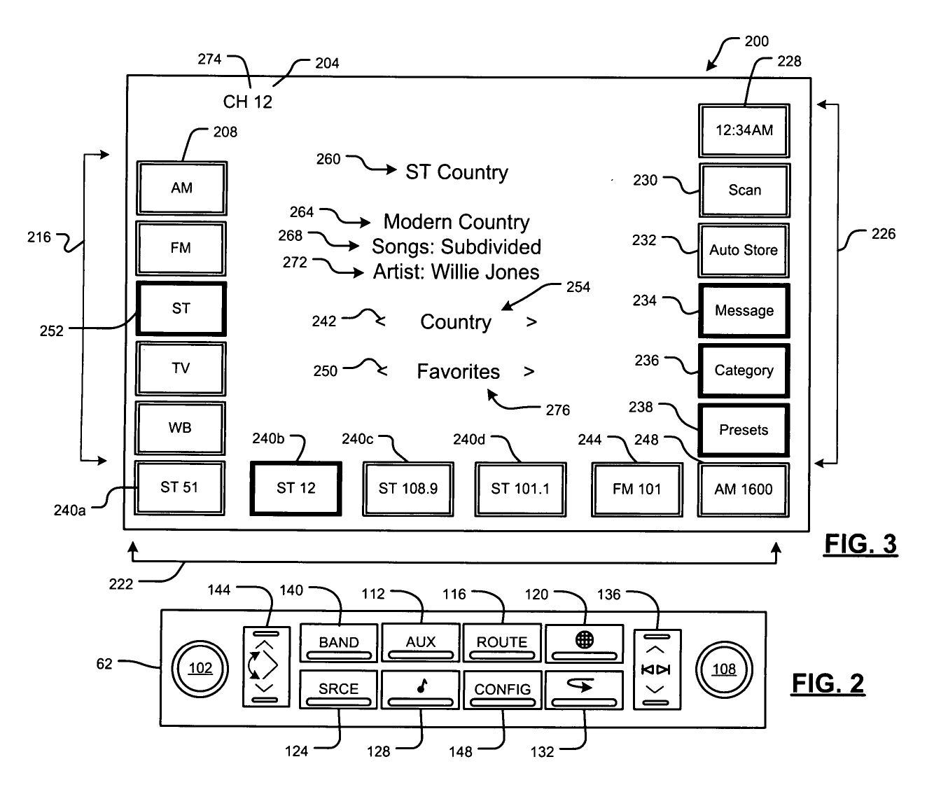

One configuration of the manual interface 62 is shown in FIG. 2. The interface includes a power knob 102 and a tuning knob 108. The interface 62 also may include a plurality of push buttons used in connection with various systems available in the vehicle, for example, an auxiliary input button 112, a destination navigation system button 116, a map button 120, an audio source button 124, an audio adjustment button 128, a repeat button 132 and a rocker switch 136 for a seek function. A band button 140 allows the user to activate radio functions available via the radio system 20 as further described below. A rocker switch 144 allows the user to open or close the screen interface 58. A configuration button 148 allows the user to configure or reconfigure radio preset pages as further described below.

A page that may be displayed on the screen interface 58 according to one configuration of the invention is indicated generally in FIG. 3 by reference number 200. The page 200 includes a plurality of display areas 204. The page also includes a plurality of touch-activatable areas 208. An area 208 may indicate (e.g., by color and/or illumination change on the screen 58) whether the area is activated. Areas 208 include frequency band selectors 216, frequency preset selectors 222 (also referred to herein as presets) and function selectors 226. Functions 226 include a clock 228, a scan function 230 and an auto-store function 232. A message function 234, a category function 236 and a presets function 238 shall be further described below. Other touch-activatable areas 208 may include paging toggles 242 and 250, also further described below.

The frequency presets 222 make channels from a plurality of frequency bands available for selection on the same page 200. For example, the page 200 displays presets 240a-d for satellite channels, a preset 244 for a FM channel and a preset 248 for an AM channel. When a user selects a channel by touch-activating a preset 222, the system 20 responsively activates a selector 216 for a band that includes the selected channel. For example, as shown in FIG. 3, the preset 240b indicates that it has been touch-activated, and a satellite band selector 252 also indicates activation. A band selector 216 also may be touch-activated by the user to select a frequency band for reception by the system 20.

While receiving and playing a selected channel, the system 20 may display on the screen interface 58 various items of information pertaining to the selected channel. For example, it is known to include program-related information in signals broadcast over satellite-band channels, FM stations and other HD broadcasts. When the message function 234 is activated, the system 20 may display such information on the screen interface 58. For example, as shown in FIG. 3, display areas 204 include a channel name 260, a channel description 264, song information 268 and artist information 272. A channel number 274 is also displayed. When the category function 236 is activated, a user may use the toggles 242 to page through a plurality of channel categories, one of which is displayed and numbered 254 in FIG. 3 and which may be provided by a broadcast service as known in the art.

Each page displayed on the screen interface 58 may include a page name 276 which may be selected and/or changed by a user. For example, the page 200 includes a name “Favorites”. The user may name or rename preset pages as further described below. Using the toggles 250, the user can page through a plurality of display pages preset by the user.

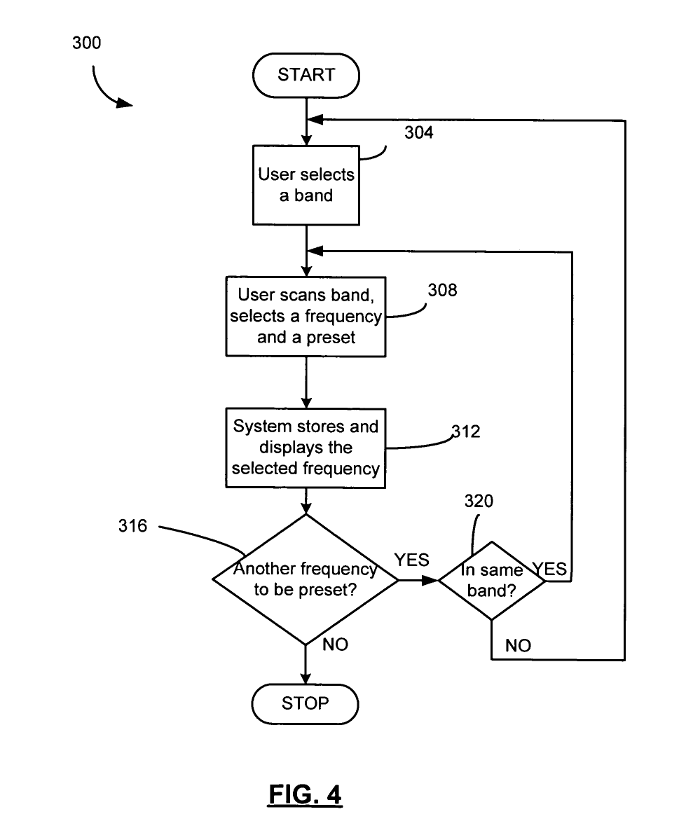

The user configures a given page of presets, for example, in accordance with a method indicated generally in FIG. 4 by reference number 300. In step 304, the user activates one of the band selectors 216 to select a frequency band. In step 308, the user activates the scan function 230 to find a desired channel. When the channel is found, the user touches and maintains contact with one of the presets 222 to set such preset 222 to the desired channel. In step 312, the system 20 stores the selected frequency, e.g., in the memory 48 and displays the selected frequency in the selected preset 222. In step 316, it is determined whether the user wishes to choose another frequency. If yes, it is determined in step 320 whether the user wishes to choose a frequency from the same band. If not, the user selects another band in step 304. Otherwise the user resumes scanning in step 308. The user may continue the foregoing process, for example, until all of the presets 222 on the given page are set. The user may also perform the method 300 to change a previously set preset 222. Other and additional ways are available to the user for locating a frequency and setting a preset. For example, the user may use the tuning knob 108 and/or seek control 136 to find a frequency. Additionally or alternatively, the user may find a channel by activating the category function 236 and using the paging control 242 to page through channel categories.

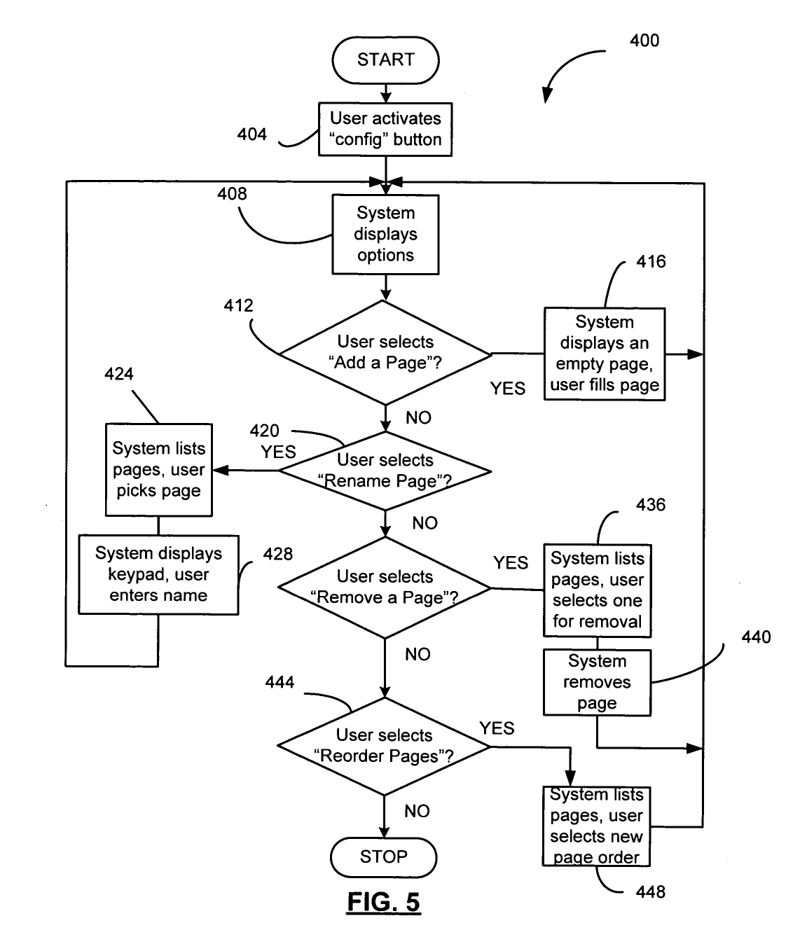

By activating the configuration button 148, a user may add, remove and/or make changes to preset pages. For example, the user may make changes to pages according to a method indicated generally in FIG. 5 by reference number 400. In step 404, the user activates the configuration button 148. In step 408, the system 20 displays a plurality of user options on the screen interface 58. In step 412, it is determined whether the user selects an option to add a new page 200. If yes, then at step 416 the system 20 may display an empty page. The user may populate the page with preset frequencies, for example, in the manner described above with reference to FIG. 4, and control returns to step 408.

In step 420, it is determined whether the user selects an option to rename a page. If yes, at step 424 the system displays a list of pages in use. The user selects the appropriate page to be renamed. In step 428, the system displays a touch activatable alphanumeric keypad on the screen interface 58, and the user activates the keypad to enter a page name.

In step 432, it is determined whether the user selects an option to remove a page. If the user selects such option, the system lists pages in use in step 436, and the user selects a page desired to be removed. In step 440, the system 20 removes the selected page, and control returns to step 408.

In step 444, it is determined whether the user selects an option to reorder pages. If yes, at step 448 the system 20 lists pages in use, and the user uses the screen interface 58 to select a new display order, for example, by entering new sequence numbers for the pages.

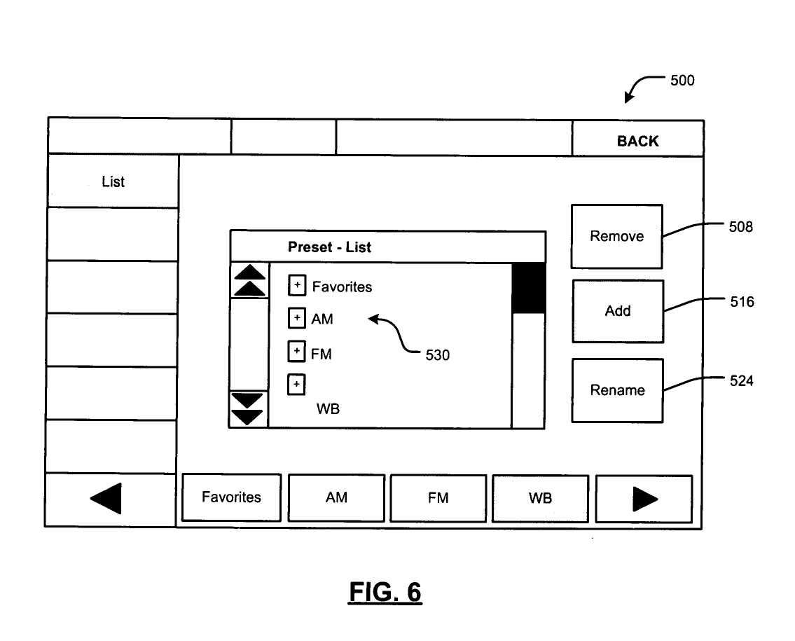

An option display according to another implementation of the invention is indicated generally in FIG. 6 by reference number 500. A remove page option 508, an add page option 516 and a rename option 524 are shown. The add page option 516 is shown as activated. In the present configuration, the system 20 includes a plurality of pre-stored pages which may not all be in use by users of the system. 20 A user may use the display 500 to select a page not currently in use in the system 20 and “add” it as a page in use, i.e., give it a new name and/or populate it with presets as desired and as described above. A list 530 of page names includes pages in use (indicated by “+”) and a page named “WB” being added by the user.

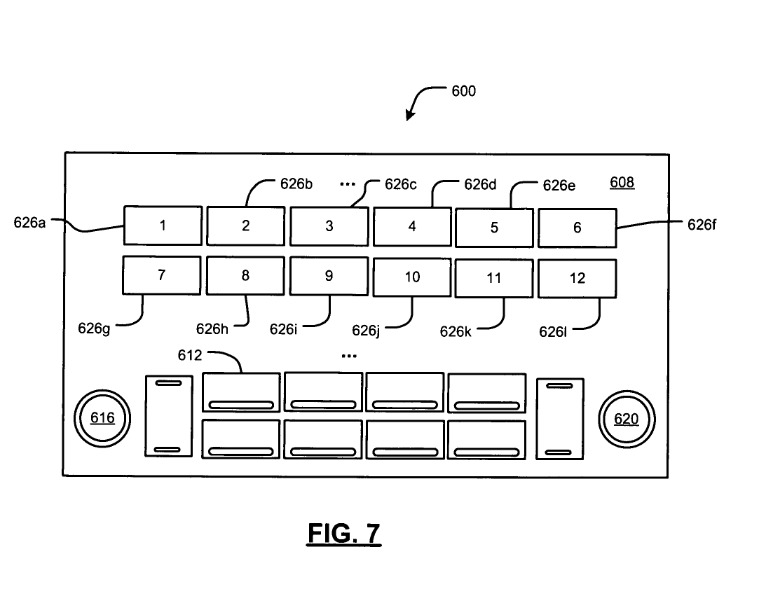

Another configuration of an interface is indicated generally in FIG. 7 by reference number 600. The interface 600 includes a radio faceplate 608 in which a plurality of buttons 612 are displayed. A power knob 616 and tuning knob 620 are provided as known in the art. Included in the buttons are a plurality of preset buttons, e.g., presets 626a through 6261. The buttons 626 can be preset to channels in different bands and are available for activation by a user without having to first select a desired band. For example, buttons 626a and 626k may be preset to AM channels while buttons 626c and 626f may be preset to an FM channel, and so on. When, for example, the user is listening to one of the preset AM channels and wishes to change to one of the preset FM channels, the user may press the appropriate button (e.g., button 626f) to receive the channel without having to first switch bands.

The above described system provides a user with flexibility to utilize allotted presets according to the user's preference(s), without being restricted to a fixed allocation of “pages” or capacity per band. The system minimizes toggling by the user through multiple radio band “preset pages”. Where the foregoing system is implemented in a vehicle, a driver can operate the system in fewer steps, in less time and with less potential for distraction than would be the case with a conventional system. The foregoing system promotes driver satisfaction with both the radio system and the vehicle in which the system is installed.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification, and the following claims.

1. A radio system that receives signals in multiple frequency bands, the system comprising:
a control module; and
an interface module that communicates with the control module and that provides at least one of a user interface and a display;
wherein the interface module and the control module allow a user to store frequencies as preset frequencies from more than one frequency band;
wherein the control module and the interface module present the preset frequencies for selection; and
wherein at least two of the preset frequencies that are simultaneously presented are from different frequency bands.

2. The system of claim 1 wherein the interface module displays a page in which frequencies from more than one band are displayed.

3. The system of claim 2 wherein the page comprises a name modifiable by the user.

4. The system of claim 1 wherein the interface module presents the preset frequencies in a plurality of pages presentable sequentially to the user.

5. The system of claim 4 wherein the pages may be reordered by the user.

6. The system of claim 4 wherein one of the pages is renamed by the user.

7. A radio system operable to receive signals at a plurality of frequencies selected by a user, the system comprising:
a control module; and
an interface module that communicates with the control module to present a subset of the selected frequencies, to allow the user to choose a frequency from the subset for reception by the radio system,
wherein the presented subset comprises frequencies in a plurality of frequency bands that are presented simultaneously.

8. The radio system of claim 7 wherein the plurality of frequencies selected by the user are selected by the user via the interface module.

9. The radio system of claim 7 wherein the interface module presents a plurality of subsets of the selected frequencies in a plurality of pages, and wherein each page includes a subset.

10. The radio system of claim 9 wherein one of the pages comprises a plurality of activation areas for paging through the plurality of pages.

11. The radio system of claim 7 wherein the interface module presents the subset on a single page, the page comprising activation areas whereby the user may choose one of the selected frequencies.

12. A method of providing signal selection to a user of a radio system that receives signals from a plurality of frequency bands, the method comprising:
presenting to the user a page having a plurality of presets; and
allowing the user to set the presets to a plurality of frequencies from more than one of the bands.

13. The method of claim 12 further comprising allowing the user to select from the page one of the preset frequencies for reception by the system.

14. The method of claim 12 further comprising storing the page in a control module of the system.

15. The method of claim 12 further comprising allowing the user to name the page.

16. The method of claim 12 further comprising allowing the user to select a preset frequency from one of a plurality of pages.

17. The method of claim 12 further comprising allowing the user to remove the page.

18. The method of claim 12 further comprising selecting a band in response to the user selecting a preset frequency.
